(19) United States
(12) Patent Application Publication
(10) Pub. No.: US 2014/0082897 A1
(43) Pub. Date: Mar. 27, 2014

(54) ARTICULATING RESTRAINT DEVICE

(71) Applicant: Stage Ninja, LLC, Indianapolis, IN (US)

(72) Inventors: Brent Eskew, Indianapolis, IN (US); Clayton Willis, Indianapolis, IN (US)

(73) Assignee: Stage Ninja, LLC, Indianapolis, IN (US)

(21) Appl. No.: 14/030,234

(22) Filed: Sep. 18, 2013

Related U.S. Application Data
(60) Provisional application No. 61/702,546, filed on Sep. 18, 2012.

(51) Int. Cl. F16B 2/10

(52) U.S. Cl. CPC F16B 2/10
USPC 24/489

(57) ABSTRACT

Articulating restraint device. In an exemplary embodiment of an articulating restraint device of the present disclosure, the device comprises a clamp having two arms coupled to one another and defining opposing inner surfaces and having distal ends, at least two engagement portions, wherein at least one of the at least two engagement portions is coupled to each inner surface of each of the two arms and positioned so that when the distal ends of the clamp engage one another, the at least two engagement portions do not engage one another, and at least one articulating arm member, each articulating arm member being relatively cylindrical and defining a first end opening at a first end, an opposing second end opening at a second end, and a tapered central portion, whereby two adjacent articulating arm members can engage and reversibly couple to one another.

### PRIORITY

The present U.S. nonprovisional patent application is related to, and claims the priority benefit of, U.S. provisional patent application Ser. No. 61/702,546 filed Sep. 18, 2012, the contents of which are hereby incorporated by reference in their entirety into this disclosure.

### BACKGROUND

Stage technicians, whether involved with musicians or other performers, have the daunting task of assembling not only the physical stage and lighting equipment for any given performance, but also preparing the musical and other equipment for ready use by the performers. Especially in view of advances in technology, many performers are using digital and other equipment in connection with their performances.

Problems exist with such assemblies and preparations in that certain useful equipment has not been previously available in the marketplace to not only secure certain equipment where desired, but to allow said equipment to be adjusted as desired without fear of the equipment being unsecured. The devices and kits of the present disclosure solve those problems, and would be well-received in the marketplace.

### BRIEF SUMMARY

In an exemplary embodiment of an articulating restraint device of the present disclosure, the device comprises a clamp having two arms coupled to one another, each of the two arms defining opposing inner surfaces and having distal ends, at least two engagement portions, wherein at least one of the at least two engagement portions is coupled to each inner surface of each of the two arms and positioned so that when the distal ends of the clamp engage one another, the at least two engagement portions do not engage one another, and a plurality of interlocked individual articulating arm members, each articulating arm member being relatively cylindrical and defining a first end opening at a first end, an opposing second end opening at a second end, and a tapered central portion, whereby two adjacent articulating arm members can engage and reversibly couple to one another by positioning the second end of a first articulating arm member within the first end opening of an adjacent second articulating arm member, wherein one of the plurality of articulating arm members is coupled to one of the two arms of the clamp. In another embodiment, each of the at least two engagement portions comprise a material selected from the group consisting of rubber, foam, and foam rubber. In yet another embodiment, when the clamp is opened and positioned around a cylindrical object, closure of the clamp around at least part of the cylindrical object causes the at least two engagement portions to engage the cylindrical object. In an additional embodiment, the clamp remains in place relative to the cylindrical object upon closure of the clamp around at least part of the cylindrical object. In yet an additional embodiment, the cylindrical object is selected from the group consisting of a pole, a microphone stand, scaffolding, and stage equipment.

In an exemplary embodiment of an articulating restraint device of the present disclosure, when the clamp is opened and each of the two arms are positioned with a portion of a body therebetween, closure of the clamp upon at least part of the body causes the at least two engagement portions to engage the body. In an additional embodiment, the clamp remains in place relative to the body upon closure of the clamp upon at least part of the body. In yet an additional embodiment, the body is selected from the group consisting of a table, a desk, musical equipment, and stage equipment.

In an exemplary embodiment of an articulating restraint device of the present disclosure, a most distal articulating arm member is configured to reversibly engage an external product. In another embodiment, the external product is selected from the group consisting of a microphone, a tablet computer, a telephone, a smartphone, a personal digital assistant, a digital music player, a laptop computer, a camera, a camcorder, a flashlight, a speaker, and a retention platform. In yet another embodiment, the external product comprises a portable electronic device. In an additional embodiment, the external product comprises a retention platform configured to retain a second external product. In yet an additional embodiment, the retention platform comprises a plurality of retention arms having retention flanges and a tension clip, whereby the retention flanges and the tension clip are configured to retain the second external product. In another embodiment, the second external product is selected from the group consisting of a microphone, a tablet computer, a telephone, a smartphone, a personal digital assistant, a digital music player, a laptop computer, a camera, a camcorder, a flashlight, and a speaker.

In an exemplary embodiment of an articulating restraint device of the present disclosure, the device further comprises a locking mechanism positioned within at least one articulating arm member, wherein the one of the plurality of articulating arm members is coupled to one of the two arms of the clamp using the locking mechanism. In an additional embodiment, the locking mechanism comprises a threaded bolt having a head portion and a threaded portion, a first washer, a second washer, and a nut, wherein the first washer, the second washer, and the nut are all positioned on the threaded portion of the threaded bolt. In yet an additional embodiment, the first washer is positioned within the first end opening of at least one articulating arm member, the threaded bolt is positioned within the first end opening and through the washer so that the head portion of the threaded bolt remains within the first end opening, the second washer is positioned upon the threaded portion of the threaded bolt within the second end opening, and wherein the nut is positioned upon the threaded portion of the threaded bolt within the second end opening to secure the second washer within the at least one articulating arm member. In another embodiment, the device further comprises a separate adapter coupled to the threaded bolt, the separate adapter configured to reversibly engage an external product.

In an exemplary embodiment of an articulating restraint device of the present disclosure, the device further comprises at least one splitter coupled to at least one of the articulating arm members, the at least one splitter configured to receive up to two additional articulating arm members. In another embodiment, the at least one splitter defines a first splitter end, a second splitter end, and a third splitter end, wherein each end is configured to receive the at least one articulating arm member. In yet another embodiment, the at least two engagement portions face one another.

In an exemplary embodiment of an articulating restraint device of the present disclosure, the device comprises a clamp having two arms coupled to one another, each of the two arms defining opposing inner surfaces and having distal ends, at least two engagement portions, wherein at least one of the at least two engagement portions is coupled to each inner surface of each of the two arms and positioned so that when the distal ends of the clamp engage one another, the at least two engagement portions do not engage one another, and at least one articulating arm member, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member, wherein one articulating arm member of the at least one articulating arm members is coupled to one of the two arms of the clamp. In another embodiment, the at least one articulating arm member comprises a plurality of interlocked articulating arm members.

In an exemplary embodiment of an articulating restraint device of the present disclosure, the device comprises a magnetic base comprising a magnet, and a plurality of interlocked individual articulating arm members, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member, wherein one of the plurality of articulating arm members is coupled to the magnetic base. In another embodiment, the magnetic base is configured to attract to and magnetically engage a metallic substrate. In yet another embodiment, when the magnetic base is attracted to and engages a metallic substrate, the magnetic base remains in place relative to the metallic substrate. In an additional embodiment, the magnetic base further comprises a base housing configured to receive at least part of the magnet.

In an exemplary embodiment of an articulating restraint device of the present disclosure, the device further comprises a locking mechanism positioned within at least one articulating arm member, wherein the one of the plurality of articulating arm members is coupled to the magnetic base using the locking mechanism. In an additional embodiment, the locking mechanism comprises a threaded bolt having a head portion and a threaded portion, a washer, and a nut, wherein the washer and the nut are positioned on the threaded portion of the threaded bolt. In yet an additional embodiment, the threaded bolt is positioned within the magnetic base so that the head portion of the threaded bolt contacts the magnetic base, the washer is positioned upon the threaded portion of the threaded bolt within one of the first end opening and the second end opening, and wherein the nut is positioned upon the threaded portion of the threaded bolt within the one of the first end opening and the second end opening to secure the washer within the at least one articulating arm member. In another embodiment, the locking mechanism comprises (i) a rivet having a rivet head, and (ii) a washer, wherein the washer is positioned on the rivet. In yet another embodiment, the rivet is positioned within the magnetic base so that the rivet head contacts the magnetic base, the washer is positioned upon the rivet within one of the first end opening and the second end opening, and wherein a distal end of the rivet is expanded within the one of the first end opening and the second end opening to secure the washer within the at least one articulating arm member.

In an exemplary embodiment of an articulating restraint device of the present disclosure, the device comprises a magnetic base comprising a magnet, and at least one articulating arm member, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member, wherein one articulating arm member of the at least one articulating arm members is coupled to the magnetic base. In another embodiment, the at least one articulating arm member comprises a plurality of interlocked articulating arm members.

In an exemplary embodiment of an articulating restraint device of the present disclosure, the device comprises a restraint mechanism selected from the group consisting of (i) a clamp having two arms coupled to one another, each of the two arms defining opposing inner surfaces and having distal ends, and (ii) a magnetic base comprising a magnet, at least one articulating arm member, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member, wherein one articulating arm member of the at least one articulating arm members is coupled to the restraint mechanism. In another embodiment, the restraint mechanism comprises the clamp having the two arms coupled to one another, each of the two arms defining the opposing inner surfaces and having the distal ends. In yet another embodiment, the device further comprises at least two engagement portions, wherein at least one of the at least two engagement portions is coupled to each inner surface of each of the two arms and positioned so that when the distal ends of the clamp engage one another, the at least two engagement portions do not engage one another. In an additional embodiment, the one articulating arm member of the at least one articulating arm members is coupled to one of the two arms of the clamp. In yet an additional embodiment, the at least one articulating arm member comprises a plurality of interlocked articulating arm members.

In an exemplary embodiment of an articulating restraint device of the present disclosure, the restraint mechanism comprises the magnetic base comprising the magnet. In various embodiments of devices of the present disclosure, one or more device components comprise a material selected from the group consisting of plastic and metal.

In an exemplary embodiment of a kit of the present disclosure, the kit comprises an exemplary restraint mechanism of the present disclosure and at least one articulating arm member.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows an articulating restraint device, according to an exemplary embodiment of the present disclosure;

FIG. 2 shows an articulating arm member of an exemplary device, according to an exemplary embodiment of the present disclosure;

FIG. 3 shows two articulating arm members coupled to one another, according to an exemplary embodiment of the present disclosure;

FIG. 4 shows a clamp having two engagement portions used to engage a cylindrical object, according to an exemplary embodiment of the present disclosure;

FIG. 5 shows a clamp having two engagement portions used to engage a body, according to an exemplary embodiment of the present disclosure;

FIG. 6 shows a device comprising a clamp, a plurality of articulating arm members, and an external product coupled thereto, according to an exemplary embodiment of the present disclosure;

FIG. 7A shows a top perspective view of a first side of two exemplary articulating arm members with locking mechanisms positioned therein, according to exemplary embodiments of the present disclosure;

FIG. 7B shows a top perspective view of an opposing second side of two exemplary articulating arm members with locking mechanisms positioned therein, according to exemplary embodiments of the present disclosure;

FIG. 8 shows a splitter, according to an exemplary embodiment of the present disclosure;

FIG. 9A shows a top perspective view of a first side of a magnetic base, according to an exemplary embodiment of the present disclosure; and

FIG. 9B shows a top perspective view of an opposing second side of a magnetic base, according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

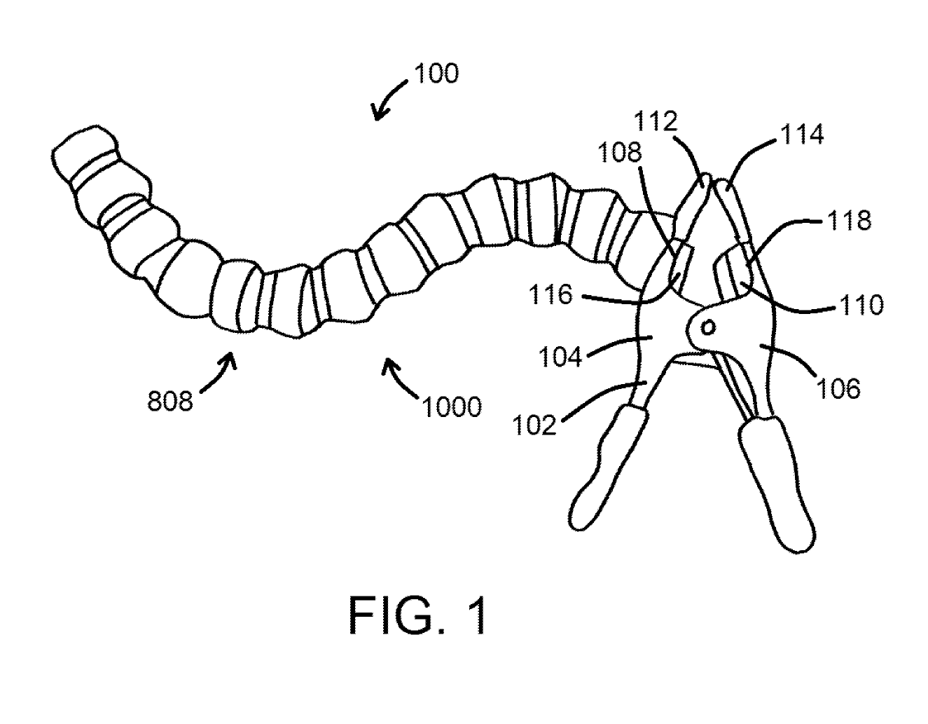

An exemplary articulating restraint device of the present disclosure is shown in FIG. 1. As shown in FIG. 1, device 100 comprises a clamp 102 having two arms 104, 106 coupled to one another, each of the two arms 104, 106 defining opposing inner surfaces 108, 110 and having distal ends 112, 114. As shown in FIG. 1, and in various embodiments, device 100 further comprises at least two engagement portions 116, 118, wherein at least one engagement portion (such as engagement potion 116) is coupled to one inner surface (such as inner surface 108) of one arm (such as arm 104), and wherein at least another engagement portion (such as engagement portion 118) is coupled to the other inner surface (such as inner surface 110) of the other arm (such as arm 106), so that when distal ends 112, 114 of clamp 102 engage one another, engagement portions 116, 118 do not engage one another.

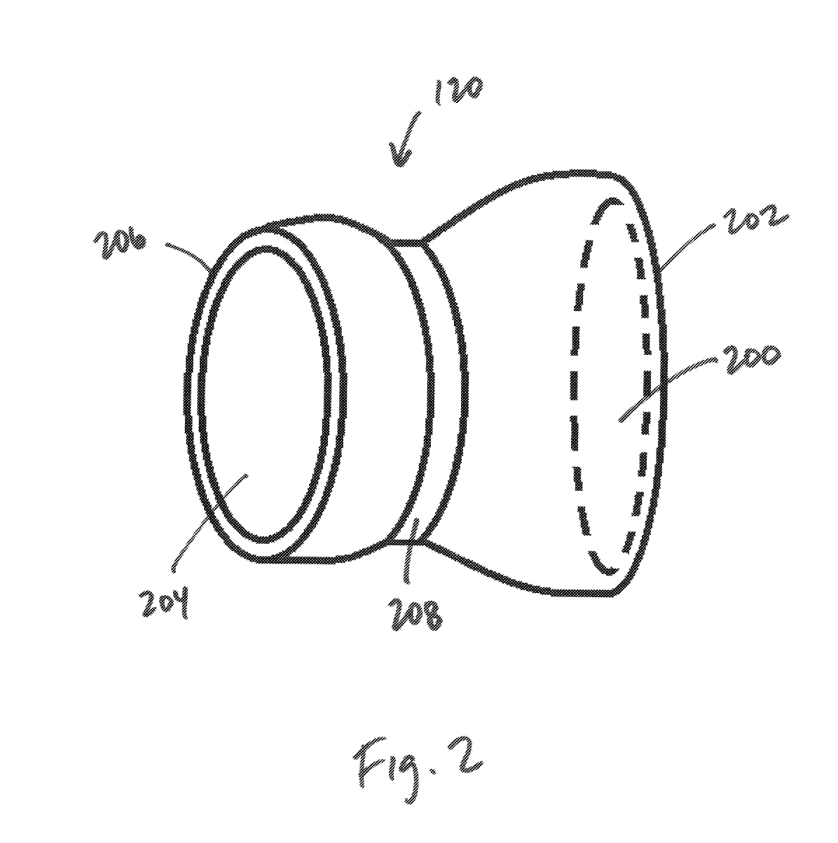

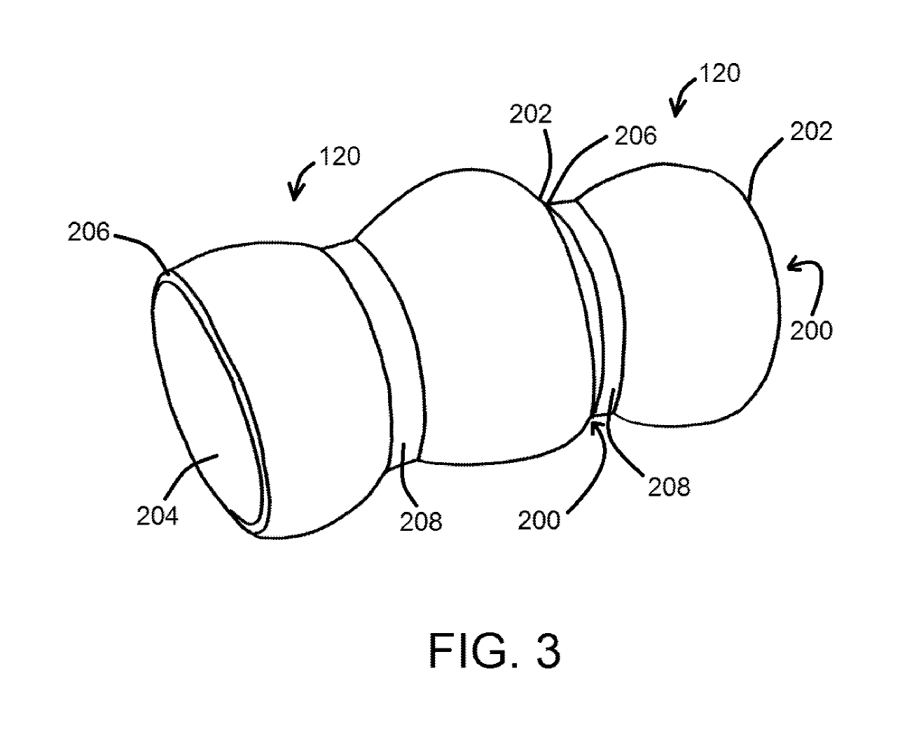

As shown in FIGS. 1 and 3, and in various embodiments, exemplary devices 100 of the present disclosure further comprise a plurality of interlocked individual articulating arm members 120, each articulating arm member 120 being relatively cylindrical and defining, as shown in FIG. 2, a first end opening 200 at a first end 202, an opposing second end opening 204 at a second end 206, and a tapered central portion 208, whereby two adjacent articulating arm members 120, as shown in FIG. 3, can engage and reversibly couple to one another by positioning the second end 206 of a first articulating arm member 120 within the first end opening 200 of an adjacent second articulating arm member 120. As shown in FIG. 1, and in at least some embodiments, at least one of the plurality of articulating arm members 120 is coupled to one of the two arms 104, 106 of clamp 102.

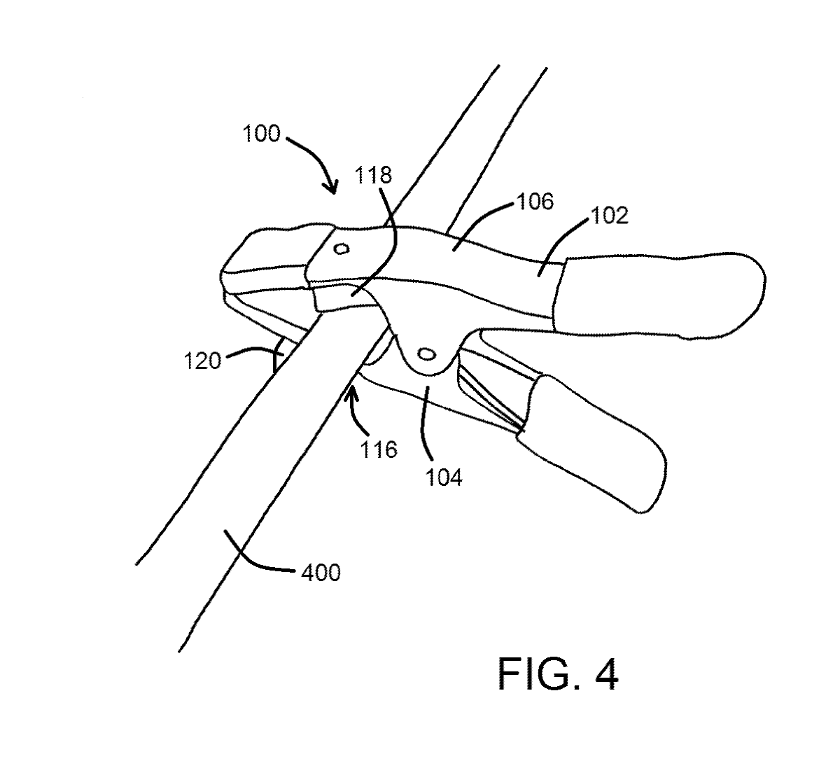

In at least one embodiment of a device 100 of the present disclosure, each of the engagement portions 116, 118 comprise a material selected from the group consisting of rubber, foam, and foam rubber. Such materials allow clamp 102, when opened and positioned around a cylindrical object 400 as shown in FIG. 4, to close around at least part of cylindrical object 400 and cause engagement portions 116, 118 to engage cylindrical object 400. In at least one embodiment, clamp 102 remains in place relative to cylindrical object 400 upon closure of clamp 102 around at least part of cylindrical object 400. Clamp 102, in various embodiments, remains in place due to the clamping force and friction between engagement portions 116, 118 and cylindrical object 400. Should clamp 102 be made of metal and have no engagement portions 116, 118, closure around cylindrical object 400 may allow clamp 102 to initially clamp cylindrical object 400, but a lack of friction between clamp 102 and cylindrical object 400 would cause clamp 102 to either slide in a first or second direction about cylindrical object 400 and/or rotate around cylindrical object 400 with relative ease, or even slide downwards due to gravity and potentially vibration, which would be undesirable if the intended purpose is to have clamp 102 remain in place, and not move with any relative ease, around cylindrical object 400. In addition, and in at least one embodiment, the spongy/pliable properties of engagement portions 116, 118 allow a single sized clamp 102 to engage a range of sizes of cylindrical objects 400 and remain in place at an intended location about cylindrical object 400. In various embodiments, cylindrical object 400 can be a pole, a microphone stand, scaffolding, stage equipment, or another cylindrical object 400 known or developed in the art.

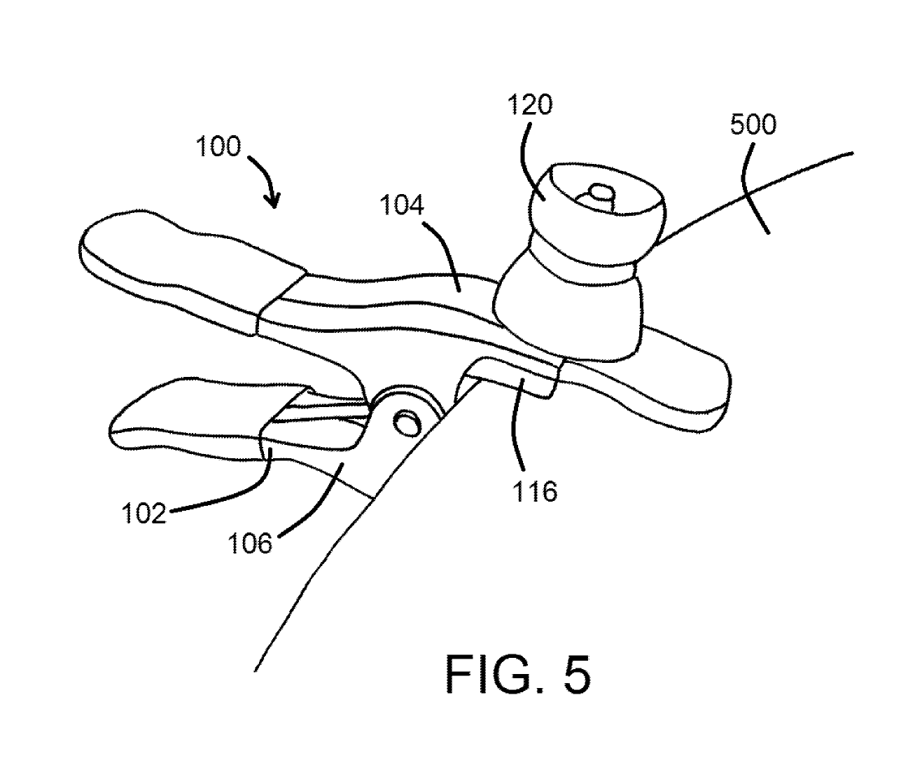

In various embodiments of clamps 102 of the present disclosure, when clamp 102 is opened and each of the two arms 104, 106 are positioned with a portion of a body 500 therebetween as shown in FIG. 5, closure of clamp 102 upon at least part of body 500 causes the at least two engagement portions 116, 118 to engage body 500. In FIG. 5, and due to the configuration of body 500, only engagement portion 116 can be seen in the figure, but as depicted, engagement portion 118 contacts the relative opposite side of body 500. As shown in FIG. 5, clamp 102 remains in place relative to body 500 upon closure of clamp 102 upon at least part of body 500, which is due to the clamping force and friction between engagement portions 116, 118 and body 500. Should clamp 102 be made of metal (or another relatively hard and non-spongy/compliant material) and have no engagement portions 116, 118, closure around/about part of body 500 may allow clamp 102 to initially clamp body 500, but a lack of friction between clamp 102 and body 500 would cause clamp 102 to move relative to body 500 with relative ease, which would be undesirable if the intended purpose is to have clamp 102 remain in place, and not move with any relative ease, around/about body 500. In addition, and in at least one embodiment, the spongy/pliable properties of engagement portions 116, 118 allow a single sized clamp 102 to engage a range of sizes of bodies 500 and remain in place at an intended location around/about body 500. In various embodiments, body 500 can be a table, a desk, musical equipment, stage equipment, or another body 500 known or developed in the art.

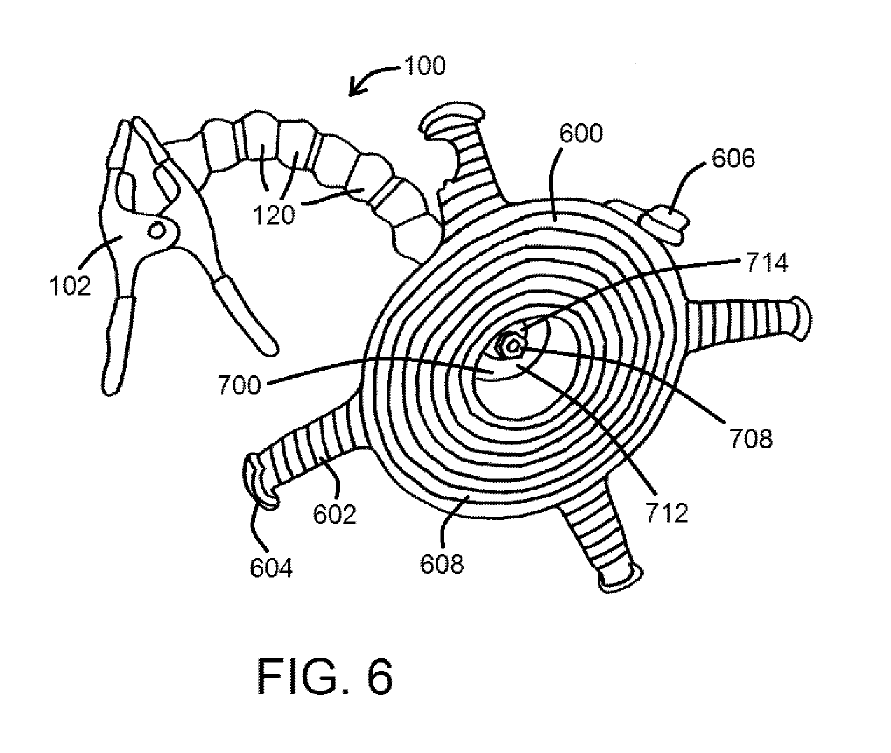

As shown in FIG. 6, and in at least one embodiment of a device 100 of the present disclosure, a most distal articulating arm member 120 is configured to reversibly engage an external product 600. External products 600, in various embodiments, can be one or more of a microphone, a tablet computer, a telephone, a smartphone, a personal digital assistant, a digital music player, a laptop computer, a camera, a camcorder, a flashlight, a speaker, a retention platform (as referenced in further detail herein), and/or other external products 600 known or developed in the art, such as a portable electronic device or other product 600. As shown in FIG. 6, an exemplary device 100 of the present disclosure comprises a clamp 102 having two engagement portions 116, 118, a plurality of interlocked individual articulating arm members 120, and an external product 600 configured to retain another external product 600, such as a tablet computer (such as an Apple® iPad®, a Kindle®, and the like), a smartphone (such as an Apple® iPhone, a Samsung® Galaxy®, a Motorola® Droid®, and the like), a digital music player (such as an Apple® iPod®, a SanDisk® Sansa®, and the like), and/or a laptop computer, for example. Such an embodiment may be referred to herein as a “retention platform,” meaning an external product 600 configured to retain another external product 600.

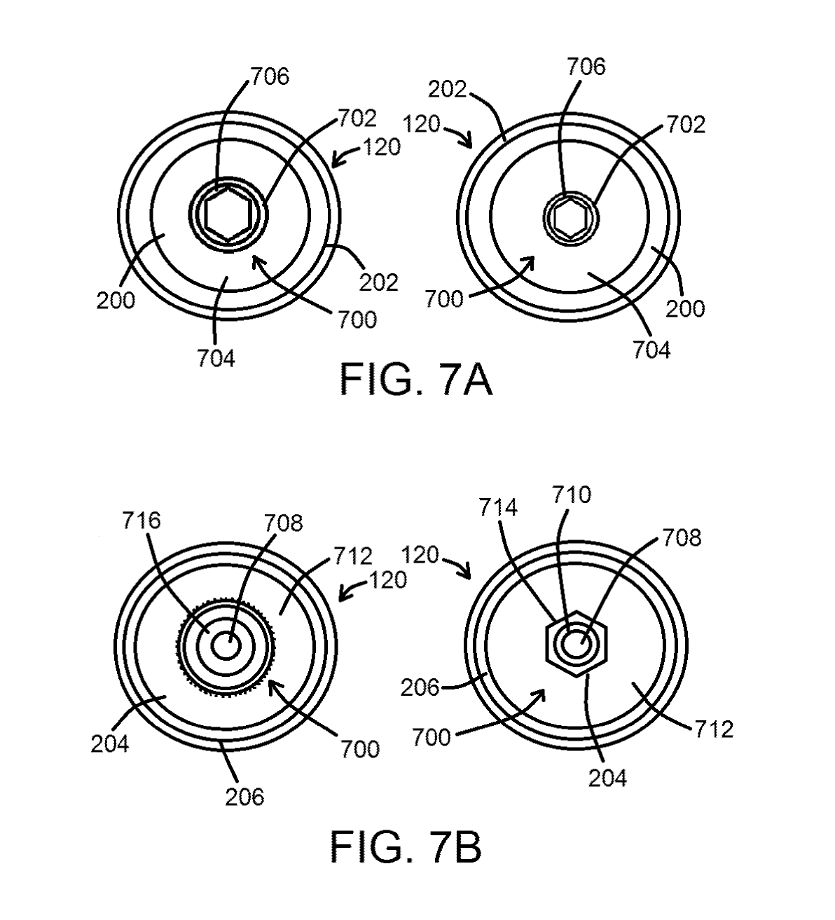

Exemplary devices 100 of the present disclosure also include various locking mechanisms useful to connect articulating arm members 120 to clamp(s) 102, external product(s) 600, and/or other objects. As shown in FIG. 7A, exemplary arm members 120 comprise a locking mechanism 700 comprising a threaded bolt 702 and a first washer 704, whereby first washer 704 is positioned within first end opening 200 of arm member 120 and is sized and shaped so not to extend through arm member 120. In at least one embodiment, first washer 704 is sized and shaped so that it fits within first end opening 200 but does not extend further through arm member 120 due to the size of tapered cylindrical portion 208. Threaded bolt 702, in at least one embodiment, can be inserted into first end opening 200 of arm member 120 and through first washer 704, so that a head portion 706 of threaded bolt contacts first washer 704.

The exemplary arm members 120 are shown in FIG. 7B with their relative opposite sides shown as compared to the depictions shown in FIG. 7A. As shown in FIG. 7B, the distal ends 708 of threaded portions 710 of threaded bolts 702 are shown, whereby threaded portions 710 are extended through second washers 712 positioned within the second end opening 204 of each arm member 120. As shown therein, and in various embodiments, second washers 712 are sized and shaped so that they fit within second end opening 204 but do not extend further through arm member 120 due to the size of tapered cylindrical portion 208. A nut 714 can be threaded along threaded portion 710 of threaded bolts 702 and tightened so that nut 714 contacts second washer 712. Such exemplary locking mechanisms 700, with or without a separate adapter 716 positioned upon threaded bolt 702 as shown in FIG. 7B, result in arm members 120 with a portion of threaded bolt 702 and/or adapter 716 extending therefrom, whereby the extended portion of threaded bolt 702 and/or adapter 716 can be used to engage to clamp(s) 102, external product(s) 600, and/or other objects. In various other embodiments, threaded bolt 702, first washer 704, second washer 712, nut 714, and adapter 716 can be positioned in an opposite configuration, so that a portion of threaded bolt 702 and/or adapter 716 extends from first end 202 of arm member 120 instead of extending from second end 206 of arm member 120 as shown in FIG. 7B.

The locking mechanisms 700 shown in FIGS. 7A and 7B and described herein are but a few exemplary embodiments of potential locking mechanisms 700 of the present disclosure. For example, locking mechanisms 700 shown in FIGS. 7A and 7B are configured so that one or more external products 600 and/or an adapter 716 can be coupled thereto by, for example, threading external products 600, adapters 716, and or other componentry onto threaded portion 710 of threaded bolt 702. In addition, and as shown in FIG. 6, external product 600 can itself be positioned over threaded bolt 702 (with or without actually being rotated/screwed onto threaded bolt 702), an optional second washer 712 can be inserted, and nut 714 can then be threaded over threaded bolt 702 to secure external product 600 in place.

As shown in FIG. 6, an exemplary external product 600, as referenced above, may be configured to retain another external product 600, such as a tablet computer (such as an Apple® iPad®, a Kindle®, and the like), a smartphone (such as an Apple® iPhone, a Samsung® Galaxy®, a Motorola® Droid®, and the like), a digital music player (such as an Apple® iPod®, a SanDisk® Sansa®, and the like), and/or a laptop computer, for example. The exemplary external product 600, shown in FIG. 6 and depending on size, is configured to retain one or more of the electronic exemplary external products 600 referenced above. Such a configuration, for example, may be provided by external product 600 having a plurality of retention arms 602 with a retention flange 604 at or near one end, and a tension clip 606 used to further secure an electronic external product 600 in place. As shown in FIG. 6, and in at least one embodiment, retention arms 602 and tension clip 606 extend from a centralized base 608 of external product.

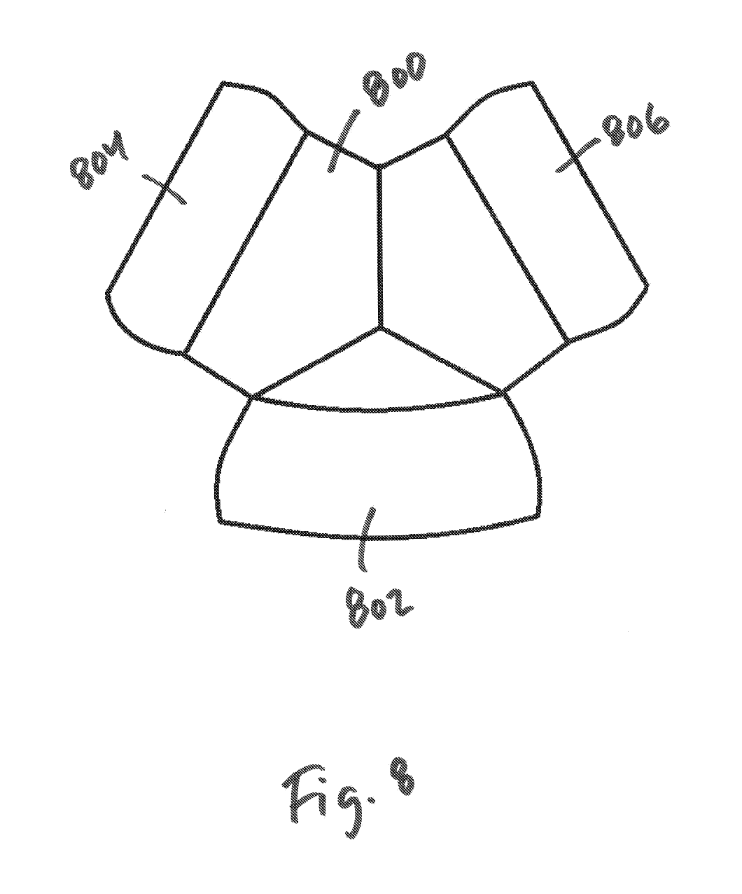

An exemplary device 800 of the present disclosure may further comprise one or more splitters 800 as shown in FIG. 8. As shown in FIG. 8, splitter 800 comprises a first splitter end 802, a second splitter end 804, and a third splitter end 806, whereby each end 802, 804, 806 is configured to engage an articulating arm member 120. Such a splitter 800 embodiment, for example, allows a user of device 100 to connect three separate chains 808 of articulating arm members 120 to splitter 800, with a chain 808 referring to a plurality of articulating arm members connected to one another, such as shown in FIG. 1.

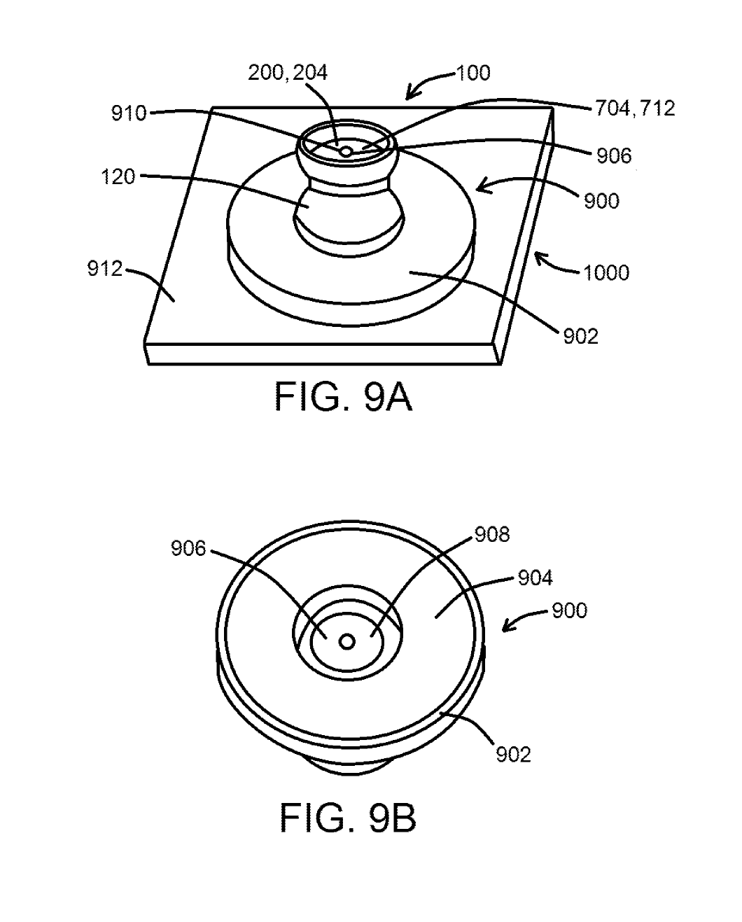

An exemplary device 800 of the present disclosure may further comprise a magnetic base 900 such as shown in FIGS. 9A and 9B. As shown in FIG. 9A, an exemplary magnetic base 900 of the present disclosure is configured to retain a first articulating arm member 120, whereby additional articulating arm members 120 can be coupled to the first articulating arm member 120. As shown in FIGS. 9A and 9B, an exemplary magnetic base 900 may comprise a base housing 902, with base housing 902 configured to at least partially retain a magnet 904 therein, as shown in FIG. 9B. Magnet 904 can be secured to base housing 902 using an adhesive, a mechanical fastener, magnetic force, and/or a combination of the same.

A locking mechanism 700 can be used to couple magnetic base 900 to a first articulating arm member 120 as shown in FIGS. 9A and 9B. As shown therein, a rivet 906 having a rivet head 908 can be positioned through the underside of base housing 902, and a washer 704 or 712 can be positioned within an opening 200 or 204 of articulating arm member 120, whereby a distal end 910 of rivet 906 can be expanded to secure rivet 906 to washer 704 or 712 and to effectively secure magnetic base 900 to articulating arm member 120. In at least another embodiment, other locking member 700 components, such as threaded bolt 702, first washer 704, head portion 706, threaded portions 710, second washer 712, and/or nut 714, can be used to secure magnetic base 900 to a first articulating arm member 120.

As referenced herein, the term “restraint mechanism” may refer to an exemplary clamp 100 and/or an exemplary magnetic base 900 of the present disclosure. Further, various components of devices 100 of the present disclosure may comprise plastic and/or metal materials.

In at least one embodiment of a kit 1000 of the present disclosure, and as shown in FIGS. 1 and 9, the kit comprises a restraint mechanism (namely a clamp 100, as shown in FIG. 1, and/or a magnetic base 900, as shown in FIG. 9A) and at least one articulating arm member 120.

An exemplary device 800 of the present disclosure may further comprise a magnetic base 900 such as shown in FIGS. 9A and 9B. As shown in FIG. 9A, an exemplary magnetic base 900 of the present disclosure is configured to retain a first articulating arm member 120, whereby additional articulating arm members 120 can be coupled to the first articulating arm member 120. As shown in FIGS. 9A and 9B, an exemplary magnetic base 900 may comprise a base housing 902, with base housing 902 configured to at least partially retain a magnet 904 therein, as shown in FIG. 9B. Magnet 904 can be secured to base housing 902 using an adhesive, a mechanical fastener, magnetic force, and/or a combination of the same.

A locking mechanism 700 can be used to couple magnetic base 900 to a first articulating arm member 120 as shown in FIGS. 9A and 9B. As shown therein, a rivet 906 having a rivet head 908 can be positioned through the underside of base housing 902, and a washer 704 or 712 can be positioned within an opening 200 or 204 of articulating arm member 120, whereby a distal end 910 of rivet 906 can be expanded to secure rivet 906 to washer 704 or 712 and to effectively secure magnetic base 900 to articulating arm member 120. In at least another embodiment, other locking member 700 components, such as threaded bolt 702, first washer 704, head portion 706, threaded portions 710, second washer 712, and/or nut 714, can be used to secure magnetic base 900 to a first articulating arm member 120. In at least one embodiment, and as shown in FIG. 9A, magnetic base 900 is configured to attract to and magnetically engage a metallic substrate 912. In various embodiments, when magnetic base 900 is attracted to and engages metallic substrate 912, magnetic base 900 remains in place relative to metallic substrate 912.

In at least one embodiment of a kit 1000 of the present disclosure, and as shown in FIGS. 1 and 9, the kit comprises a restraint mechanism (namely a clamp 100, as shown in FIG. 1, and/or a magnetic base 900, as shown in FIG. 9A) and at least one articulating arm member 120.

While various embodiments of articulating restraint devices and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. An articulating restraint device, comprising:
a clamp having two arms coupled to one another, each of the two arms defining opposing inner surfaces and having distal ends;
at least two engagement portions, wherein at least one of the at least two engagement portions is coupled to each inner surface of each of the two arms and positioned so that when the distal ends of the clamp engage one another, the at least two engagement portions do not engage one another; and
a plurality of interlocked individual articulating arm members, each articulating arm member being relatively cylindrical and defining a first end opening at a first end, an opposing second end opening at a second end, and a tapered central portion, whereby two adjacent articulating arm members can engage and reversibly couple to one another by positioning the second end of a first articulating arm member within the first end opening of an adjacent second articulating arm member;
wherein one of the plurality of articulating arm members is coupled to one of the two arms of the clamp.

2. The device of claim 1, wherein each of the at least two engagement portions comprise a material selected from the group consisting of rubber, foam, and foam rubber.

3. The device of claim 1, wherein when the clamp is opened and positioned around a cylindrical object, closure of the clamp around at least part of the cylindrical object causes the at least two engagement portions to engage the cylindrical object.

4. The device of claim 1, wherein when the clamp is opened and each of the two arms are positioned with a portion of a body therebetween, closure of the clamp upon at least part of the body causes the at least two engagement portions to engage the body.

5. The device of claim 1, wherein a most distal articulating arm member is configured to reversibly engage an external product.

6. The device of claim 5, wherein the external product is selected from the group consisting of a microphone, a tablet computer, a telephone, a smartphone, a personal digital assistant, a digital music player, a laptop computer, a camera, a camcorder, a flashlight, a speaker, and a retention platform.

7. The device of claim 5, wherein the external product comprises a retention platform configured to retain a second external product, the retention platform comprising a plurality of retention arms having retention flanges and a tension clip, whereby the retention flanges and the tension clip are configured to retain the second external product.

8. The device of claim 7, wherein the second external product is selected from the group consisting of a microphone, a tablet computer, a telephone, a smartphone, a personal digital assistant, a digital music player, a laptop computer, a camera, a camcorder, a flashlight, and a speaker.

9. The device of claim 1, further comprising:
a locking mechanism positioned within at least one articulating arm member, wherein the one of the plurality of articulating arm members is coupled to one of the two arms of the clamp using the locking mechanism.

10. The device of claim 9, wherein the locking mechanism comprises a threaded bolt having a head portion and a threaded portion, a first washer, a second washer, and a nut, wherein the first washer, the second washer, and the nut are all positioned on the threaded portion of the threaded bolt.

11. The device of claim 10, wherein the first washer is positioned within the first end opening of at least one articulating arm member, the threaded bolt is positioned within the first end opening and through the washer so that the head portion of the threaded bolt remains within the first end opening, the second washer is positioned upon the threaded portion of the threaded bolt within the second end opening, and wherein the nut is positioned upon the threaded portion of the threaded bolt within the second end opening to secure the second washer within the at least one articulating arm member.

12. The device of claim 1, further comprising:
at least one splitter coupled to at least one of the articulating arm members, the at least one splitter configured to receive up to two additional articulating arm members.

13. An articulating restraint device, comprising:
a clamp having two arms coupled to one another, each of the two arms defining opposing inner surfaces and having distal ends;
at least two engagement portions, wherein at least one of the at least two engagement portions is coupled to each inner surface of each of the two arms and positioned so that when the distal ends of the clamp engage one another, the at least two engagement portions do not engage one another; and
at least one articulating arm member, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member;
wherein one articulating arm member of the at least one articulating arm members is coupled to one of the two arms of the clamp.

14. The device of claim 13, wherein the at least one articulating arm member comprises a plurality of interlocked articulating arm members.

15. An articulating restraint device, comprising:
a restraint mechanism selected from the group consisting of (i) a clamp having two arms coupled to one another, each of the two arms defining opposing inner surfaces and having distal ends, and (ii) a magnetic base comprising a magnet;
at least one articulating arm member, each articulating arm member being relatively cylindrical and defining a first end opening at a first end, an opposing second end opening at a second end, and a tapered central portion, whereby two adjacent articulating arm members can engage and reversibly couple to one another by positioning the first end of a first articulating arm member within the second end opening of an adjacent second articulating arm member;
wherein one articulating arm member of the at least one articulating arm members is coupled to the restraint mechanism.

16. The device of claim 15, wherein the restraint mechanism comprises the magnetic base configured to attract to and magnetically engage a metallic substrate, and wherein when the magnetic base is attracted to and engages a metallic substrate, the magnetic base remains in place relative to the metallic substrate

17. The device of claim 16, wherein the magnetic base further comprises a base housing configured to receive at least part of the magnet.

18. The device of claim 16, further comprising:
a locking mechanism positioned within at least one articulating arm member, wherein the one of the plurality of articulating arm members is coupled to the magnetic base using the locking mechanism.

19. The device of claim 18, wherein the locking mechanism comprises a threaded bolt having a head portion and a threaded portion, a washer, and a nut, wherein the washer and the nut are positioned on the threaded portion of the threaded bolt, and wherein the threaded bolt is positioned within the magnetic base so that the head portion of the threaded bolt contacts the magnetic base, the washer is positioned upon the threaded portion of the threaded bolt within one of the first end opening and the second end opening, and wherein the nut is positioned upon the threaded portion of the threaded bolt within the one of the first end opening and the second end opening to secure the washer within the at least one articulating arm member.

20. The device of claim 18, wherein the locking mechanism comprises (i) a rivet having a rivet head, and (ii) a washer, wherein the washer is positioned on the rivet, and wherein the rivet is positioned within the magnetic base so that the rivet head contacts the magnetic base, the washer is positioned upon the rivet within one of the first end opening and the second end opening, and wherein a distal end of the rivet is expanded within the one of the first end opening and the second end opening to secure the washer within the at least one articulating arm member.
